(19) United States
(12) Patent Application Publication
(10) Pub. No.: US 2008/0224817 A1
(43) Pub. Date: Sep. 18, 2008

(54) INTERLACED RTD SENSOR FOR ZONE/AVERAGE TEMPERATURE SENSING

(75) Inventors: Kim R. Vellore, San Jose, CA (US); Harald Herchen, Los Altos, CA (US); Brian C. Lue, Mountain View, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: SOKUDO CO., LTD., Shimogyo-ku (JP)

(21) Appl. No.: 11/686,781

(22) Filed: Mar. 15, 2007

(51) Int. Cl. H01C 7/02

(52) U.S. Cl. 338/25

(57) ABSTRACT

A device for heating a semiconductor wafer comprises a heating element arranged to conduct heat toward the wafer. The heating element can extend along a heating element path. An RTD sensor loop can extend along an RTD sensor path. The RTD sensor path can be positioned along the heating element path to measure a temperature that corresponds to the heating element. The RTD sensor loop can measure an average temperature along the heating element. Portions of the RTD sensor can be interlaced between portions of the heating element. The heating element path can be arranged with interstices between portions of the heating element path, and portions of the RTD sensor path can be positioned within the interstices to interlace the RTD sensor loop with the heating element. The RTD sensor loop can comprise a soft metal that is resistant to oxidation and extends along the RTD sensor path.

### BACKGROUND OF THE INVENTION

The present invention relates generally to the field of substrate processing equipment. More particularly, the present invention relates to a method, apparatus and devices for measuring thermal characteristics of semiconductor processing apparatus. Merely by way of example, the method and apparatus of the present invention are used to measure bake plate temperatures using thermal sensors that extend along heating elements of the bake plate. The method and apparatus can be applied to other processes for semiconductor substrates including other processing chambers.

Modern integrated circuits contain millions of individual elements that are formed by patterning the materials, such as silicon, metal and dielectric layers, that make up the integrated circuit to sizes that are small fractions of a micrometer. The technique used throughout the industry for forming such patterns is photolithography. A typical photolithography process sequence generally includes depositing one or more uniform photoresist (resist) layers on the surface of a substrate, drying and curing the deposited layers, patterning the substrate by exposing the photoresist layer to radiation that is suitable for modifying the exposed layer and then developing the patterned photoresist layer.

It is common in the semiconductor industry for many of the steps associated with the photolithography process to be performed in a multi-chamber processing system (e.g., a cluster tool) that has the capability to sequentially process semiconductor wafers in a controlled manner. One example of a cluster tool that is used to deposit (i.e., coat) and develop a photoresist material is commonly referred to as a track lithography tool.

Track lithography tools typically include a mainframe that houses multiple chambers (which are sometimes referred to herein as stations) dedicated to performing the various tasks associated with pre- and post-lithography processing. There are typically both wet and dry processing chambers within track lithography tools. Wet chambers include coat and/or develop bowls, while dry chambers include thermal control units that house bake and/or chill plates. Track lithography tools also frequently include one or more pod/cassette mounting devices, such as an industry standard FOUP (front opening unified pod), to receive substrates from and return substrates to the clean room, multiple substrate transfer robots to transfer substrates between the various stations of the track tool and an interface that allows the tool to be operatively coupled to a lithography exposure tool in order to transfer substrates into the exposure tool and to receive substrates after they have been processed within the exposure tool.

Over the years there has been a strong push within the semiconductor industry to shrink the size of semiconductor devices. The reduced feature sizes have caused the industry's tolerance to process variability to shrink, which in turn, has resulted in semiconductor manufacturing specifications having more stringent requirements for process uniformity and repeatability. An important factor in minimizing process variability during track lithography processing sequences is to ensure that every substrate processed within the track lithography tool for a particular application has the same “wafer history.” A substrate's wafer history is generally monitored and controlled by process engineers to ensure that all of the device fabrication processing variables that may later affect a device's performance are controlled, so that all substrates in the same batch are always processed the same way.

To ensure that each substrate has the same “wafer history” requires that each substrate experiences the same repeatable substrate processing steps (e.g., consistent coating process, consistent hard bake process, consistent chill process, etc.) and the timing between the various processing steps is the same for each substrate. Lithography type device fabrication processes can be especially sensitive to variations in process recipe variables and the timing between the recipe steps, which directly affects process variability and ultimately device performance. Generally, characterization of processing operations is performed to determine the thermal properties of processing apparatus as a function of time.

Work in relation with the present invention suggests that current techniques used to determine temperatures may be somewhat indirect and less than ideal. For example, techniques that measure temperatures only at selected locations near the wafer may not measure temperatures at many locations near the wafer that can effect the wafer processing history. Although substrate supports made of highly heat conductive metals such as Aluminum may be used to spread heat from a source to provide uniform heating of the wafer, some non-uniformity in heat applied to the wafer can persist, and thermal measurements from such substrate supports can be somewhat indirect.

In view of these requirements and shortcomings, the semiconductor industry is continuously researching methods and developing tools and techniques to improve the thermal measurement capabilities associated with track lithography and other types of cluster tools.

### SUMMARY OF THE INVENTION

According to the present invention, techniques related to the field of semiconductor processing equipment are provided. More particularly, the present invention relates to a method and apparatus for measuring thermal characteristics of semiconductor processing apparatus. Merely by way of example, the method, apparatus and devices of the present invention are used to measure bake plate temperatures using thermal sensors that extend along heating elements of the bake plate. The method and apparatus can be applied to other processes for semiconductor substrates including other processing chambers.

In many embodiments, a device for heating a semiconductor wafer is provided. The device comprises a heating element arranged to conduct heat toward the wafer. The heating element can extend along a heating element path. A temperature sensor loop can extend along a temperature sensor path. The temperature sensor path can be positioned along the heating element path to measure a temperature that corresponds to the heating element.

In specific embodiments, the temperature sensor loop can measure an average temperature along the heating element. Portions of the temperature sensor can be interlaced between portions of the heating element. The heating element path can be arranged with interstices between portions of the heating element path, and portions of the temperature sensor path can be positioned within the interstices to interlace the temperature sensor loop with the heating element. The temperature sensor can comprise an RTD sensor and the path can comprise an RTD sensor loop with a soft metal that is resistant to oxidation and extends along the sensor path.

In many embodiments, a method of measuring a temperature of a bake plate used to heat a semiconductor wafer is provided. The method includes heating several heating elements. Each of the several heating elements extends along a heating element path. A temperature is measured for each of several temperature sensors. Each of the several temperature sensors extends along the heating element path of one of the several heating elements to measure a temperature that corresponds to one of the several heating elements.

In many embodiments, a device for heating a semiconductor wafer is provided. The device can comprise several heating elements arranged to conduct heat toward the wafer and several RTD sensors. Each of the several RTD sensors can extend along a path that is positioned to correspond to one of the several heating elements. In specific embodiments, the several RTD sensors are adapted to measure a uniformity of temperature from about 0.01 to 0.1 degrees C. among the heating elements.

In many embodiments, a PCB for use with a semiconductor bake plate is provided. The PCB comprises a flexible support, a heating element loop trace and an RTD sensor loop trace. The heating element loop trace can be formed on the flexible support and extend along the flexible support. The RTD sensor loop trace can be formed on the flexible support and extend along the flexible support. The RTD sensor loop trace can comprise a soft and oxidation resistant metal. The RTD sensor loop trace can be interlaced with the heating element loop trace.

Many benefits are achieved by way of the present invention over conventional techniques. For example, embodiments of the present invention provide temperature measurements of semiconductor wafers and bakeplates with improved reliability, repeatability and accuracy. Additionally, embodiments of the present invention provide for improved wafer processing history, in particular repeatable heating of semiconductor wafers with bake plates. Depending upon the embodiment, one or more of these benefits, as well as other benefits, may be achieved. These and other benefits will be described in more detail throughout the present specification and more particularly below in conjunction with the following drawings.

### BRIEF DESCRIPTION OF THE DRAWINGS

FIG. 1 is a simplified plan view of a track lithography tool according to embodiments of the present invention;

FIG. 2 is a simplified perspective view of a thermal unit according to embodiments of the present invention;

FIG. 3 is a simplified perspective view of the integrated thermal unit depicted in FIG. 2 with the top of the unit removed, according to embodiments of the present invention;

FIG. 4 is a perspective view of the bake station as shown in FIG. 3, according to embodiments of the present invention;

FIG. 5 is a perspective view of a cross-section of the bake station as shown in FIG. 4, according to embodiments of the present invention;

FIG. 6 is a cross-sectional view of bake station 20 shown in FIG. 5, according embodiments of the present invention;

FIG. 7A shows a simplified top-view of a bake plate, according to embodiments of the present invention;

FIG. 7B shows a simplified top view of an annular segment heating element of a bake plate as in FIG. 7A with an interlaced RTD sensor, according to embodiments of the present invention;

FIG. 7C shows a simplified top view of a circular heating element of a bake plate as in FIG. 7A with an interlaced RTD sensor, according to embodiments of the present invention;

FIG. 7D shows a simplified cross sectional view of a temperature sensor interlaced with a heat generation device as in FIGS. 7B and/or 7C, with the interlaced layer positioned between the wafer substrate and substrate support, according to embodiments of the present invention;

FIG. 7E shows a simplified cross sectional view of temperature sensor interlaced with a heating device as in FIGS. 7B and/or 7C, with the interlaced layer positioned beneath the substrate support, according to embodiments of the present invention;

FIG. 8A shows a simplified cross sectional view of a bake plate with an elongate temperature sensor layer positioned between a wafer substrate and a heating element layer, according to embodiments of the present invention;

FIG. 8B shows a simplified top view of a heating element layer as in FIG. 8A, according to embodiments of the present invention; and

FIG. 8C shows a simplified top view of an elongate sensor layer as in FIG. 8A, according to embodiments of the present invention.

### DETAILED DESCRIPTION OF THE INVENTION

According to the present invention, techniques related to the field of semiconductor processing equipment are provided. More particularly, the present invention relates to a method and apparatus for measuring thermal characteristics of semiconductor processing apparatus. Merely by way of example, the method, apparatus and devices of the present invention are used to measure bake plate temperatures using thermal sensors that extend along heating elements of the bake plate. The method and apparatus can be applied to other processes for semiconductor substrates including other processing chambers.

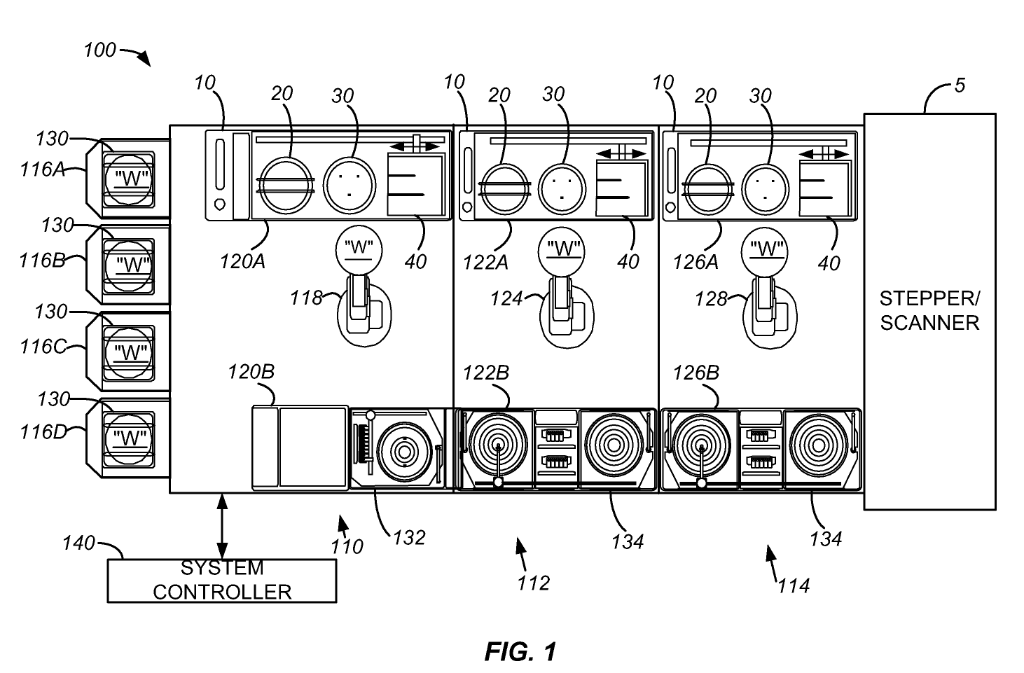

FIG. 1 is a plan view of one embodiment of a track lithography tool 100 in which the embodiments of the present invention may be used. As illustrated in FIG. 1, a cluster tool, for example track lithography tool 100, contains a front end module 110 (sometimes referred to as a factory interface), a central module 112, and a rear module 114 (sometimes referred to as a scanner interface). Front end module 110 generally contains one or more pod assemblies or FOUPS (e.g., items 116A-D), a front end robot 118, and front end processing racks 120A and 120B. The one or more pod assemblies 116A-D are generally adapted to accept one or more cassettes 130 that may contain one or more substrates, for example semiconductor material sliced to form thin semiconductor wafer substrates “W”, that are to be processed in track lithography tool 100.

Central module 112 generally contains a first central processing rack 122A, a second central processing rack 122B, and a central robot 124. Rear module 114 generally contains first and second rear processing racks 126A and 126B and a back end robot 128. Front end robot 118 is adapted to access processing modules in front end processing racks 120A and 120B; central robot 124 is adapted to access processing modules in front end processing racks 120A and 120B, central processing racks 122A and 122B and/or rear processing racks 126A and 126B; and back end robot 128 is adapted to access processing modules in the rear processing racks 126A and 126B and in some cases exchange substrates with a stepper/scanner 5.

The stepper/scanner 5, which may be purchased from Canon USA, Inc. of San Jose, Calif., Nikon Precision Inc. of Belmont, Calif., or ASML US, Inc. of Tempe Ariz., is a lithographic projection apparatus used, for example, in the manufacture of integrated circuits (ICs). The stepper/scanner tool 5 exposes a photosensitive material (resist), deposited on the substrate in the cluster tool, to some form of electromagnetic radiation to generate a circuit pattern corresponding to an individual layer of the integrated circuit (IC) device to be formed on the substrate surface.

Each of the processing racks 120A and 120B; 122A and 122B; and 126A and 126B contain multiple processing modules in a vertically stacked arrangement. That is, each of the processing racks may contain multiple stacked integrated thermal units 10, multiple stacked coater modules 132, multiple stacked coater/developer modules with shared dispense 134, or other modules that are adapted to perform the various processing steps required of a track photolithography tool. As examples, coater modules 132 may deposit a bottom antireflective coating (BARC), coater/developer modules 134 may be used to deposit and/or develop photoresist layers, and integrated thermal units 10 may perform bake and chill operations associated with hardening BARC and/or photoresist layers.

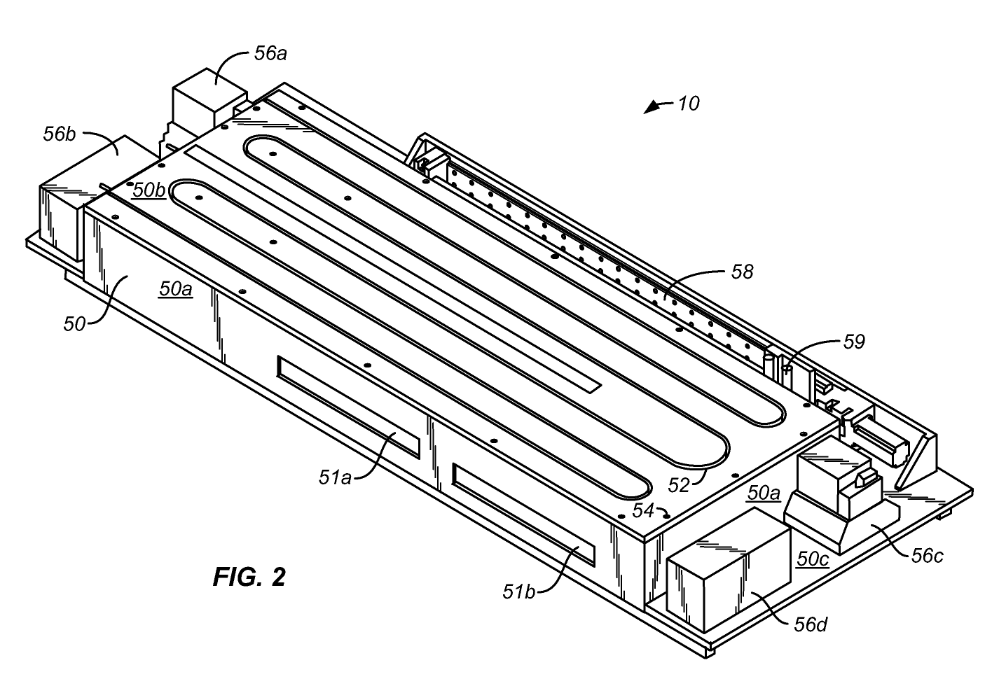

In one embodiment, a system controller 140 is used to control all of the components and processes performed in the track lithography tool 100. The controller 140 is generally adapted to communicate with the stepper/scanner 5, monitor and control aspects of the processes performed in the track lithography tool 100, and is adapted to control all aspects of the complete substrate processing sequence. In some instances, controller 140 works in conjunction with other controllers, such as controllers 56a-56d in FIG. 2, which control bake plate 22 and chill plate 30 of integrated thermal unit 10 to control certain aspects of the processing sequence. The controller 140, which is typically a microprocessor-based controller, is configured to receive inputs from a user and/or various sensors in one of the processing chambers and appropriately control the processing chamber components in accordance with the various inputs and software instructions retained in the controller's memory. The controller 140 generally contains memory and a CPU (not shown) which are utilized by the controller to retain various programs, process the programs, and execute the programs when necessary. The memory (not shown) is connected to the CPU, and may be one or more of a readily available memory, such as random access memory (RAM), read only memory (ROM), floppy disk, hard disk, or any other form of digital storage, local or remote. Software instructions and data can be coded and stored within the memory for instructing the CPU. The support circuits (not shown) are also connected to the CPU for supporting the processor in a conventional manner. The support circuits may include cache, power supplies, clock circuits, input/output circuitry, subsystems, and the like all well known in the art. A program (or computer instructions) readable by the controller 140 determines which tasks are performable in the processing chamber(s). Preferably, the program is software readable by the controller 140 and includes instructions to monitor and control the process based on defined rules and input data.

It is to be understood that embodiments of the invention are not limited to use with a track lithography tool such as that depicted in FIG. 1. Instead, embodiments of the invention may be used in any substrate processing tool including the many different tool configurations described in U.S. application Ser. No. 11/112,281 entitled “Cluster Tool Architecture for Processing a Substrate” filed on Apr. 22, 2005, which is hereby incorporated by reference for all purposes, and other configurations not described in the Ser. No. 11/112,281 application.

As shown in FIG. 2, which is a simplified perspective view of integrated thermal unit 10 depicted in FIG. 1, thermal unit 10 includes an exterior housing 50 made of aluminum or another suitable material. Housing 50 is long relative to its height in order to allow bake station 20, chill plate 30 and shuttle station 40 (shown in FIG. 1) to be laterally adjacent to each other and to allow multiple integrated thermal units to be stacked on top of each other in a track lithography tool as described above with respect to FIG. 1. In one particular embodiment, housing 50 is just 20 centimeters high.

Housing 50 includes side pieces 50a, a top piece 50b and a bottom piece 50c. Front side piece 50a includes two elongated openings 51a and 51b that allow substrates to be transferred into and out of the thermal unit. Opening 51a is operatively coupled to be closed and sealed by a shutter (not shown), and opening 51b is also operatively coupled to be closed and sealed by a shutter (also not shown). Top piece 50b of housing 50 includes coolant channels 52 that allow a coolant fluid to be circulated through the channels in order to control the temperature of top piece 50b when an appropriate plate (not shown) is attached to top piece 50b via screw holes 54. Similar coolant channels are formed in the lower surface of bottom piece 50c.

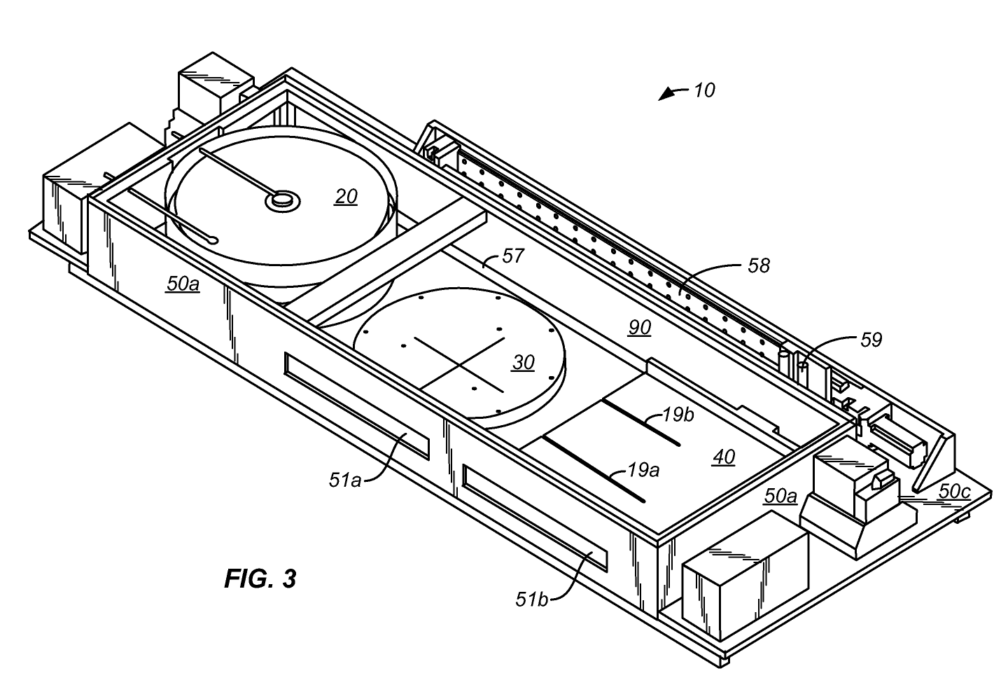

Also shown in FIG. 2 is various control circuitry 56a-56d which controls the precision baking operation of bake station 20 and the precision cooling operation of chill plate 30; and tracks 58 and 59 that enable shuttle 40 (shown in FIG. 3) to move linearly along the length of the thermal unit and vertically within the thermal unit. In one embodiment, control circuitry 56a-56b is positioned near bake station 20 and chill plate 30 in order to enable more accurate and responsive control of temperature adjusting mechanisms associated with each station.

FIG. 3 is a simplified perspective view of integrated thermal unit 10 as seen with top 50b removed. In FIG. 3, shuttle 40, chill plate 30 and bake station 20 are visible. Also visible is a space 57 between rear support piece 90 of housing 50 and bottom piece 50c. Space 57 extends along much of the length of integrated thermal unit 10 to allow shuttle 40 to transfer wafers between bake station 20 and chill plate 30.

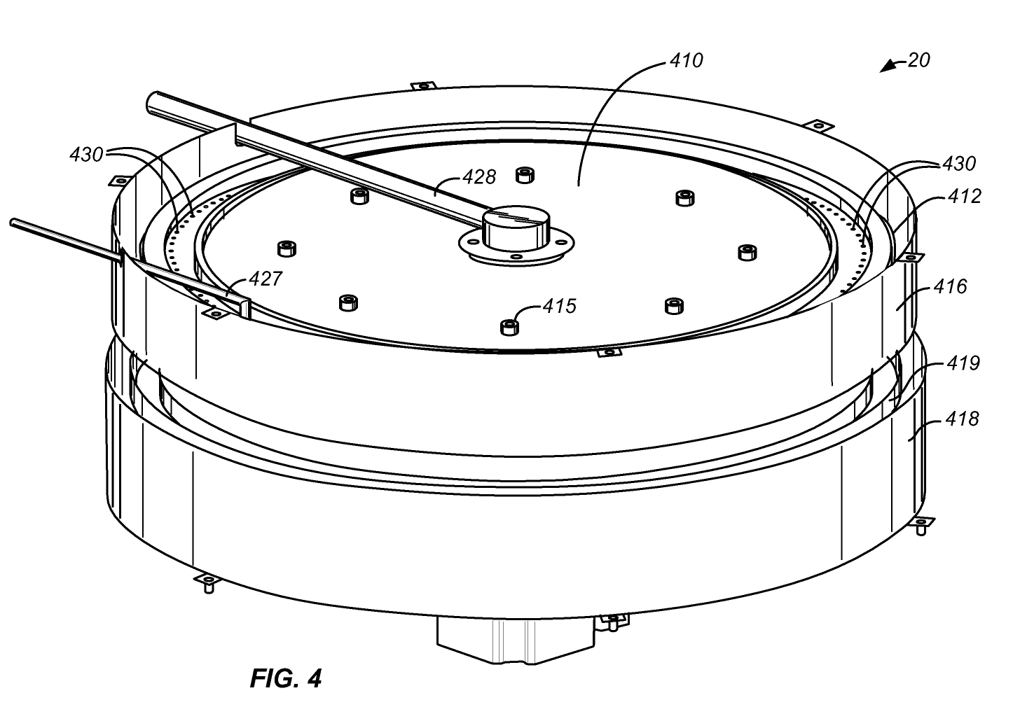

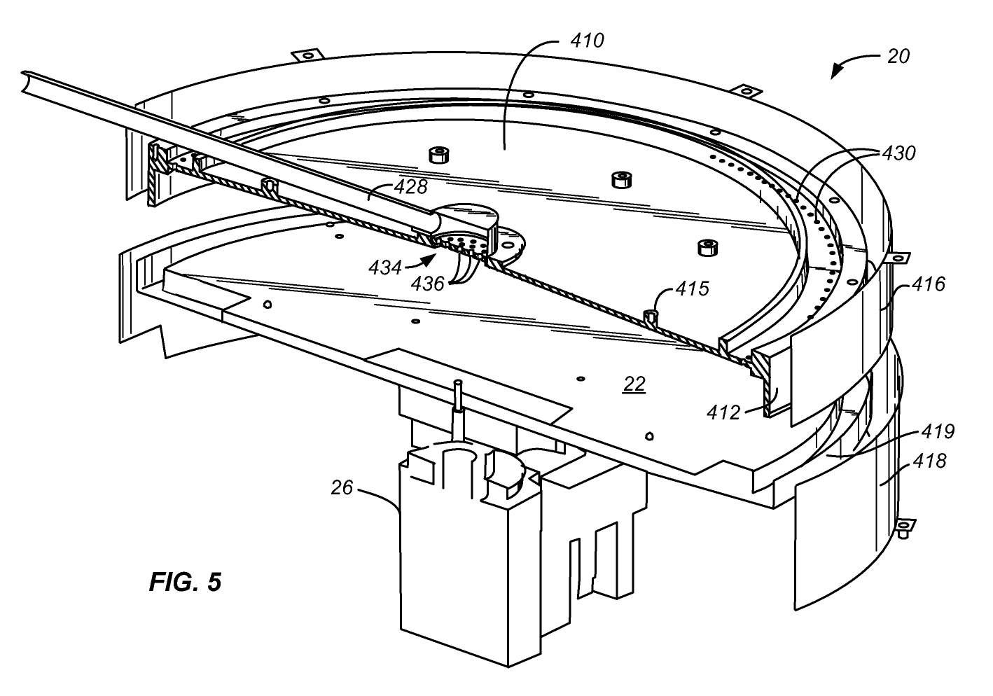

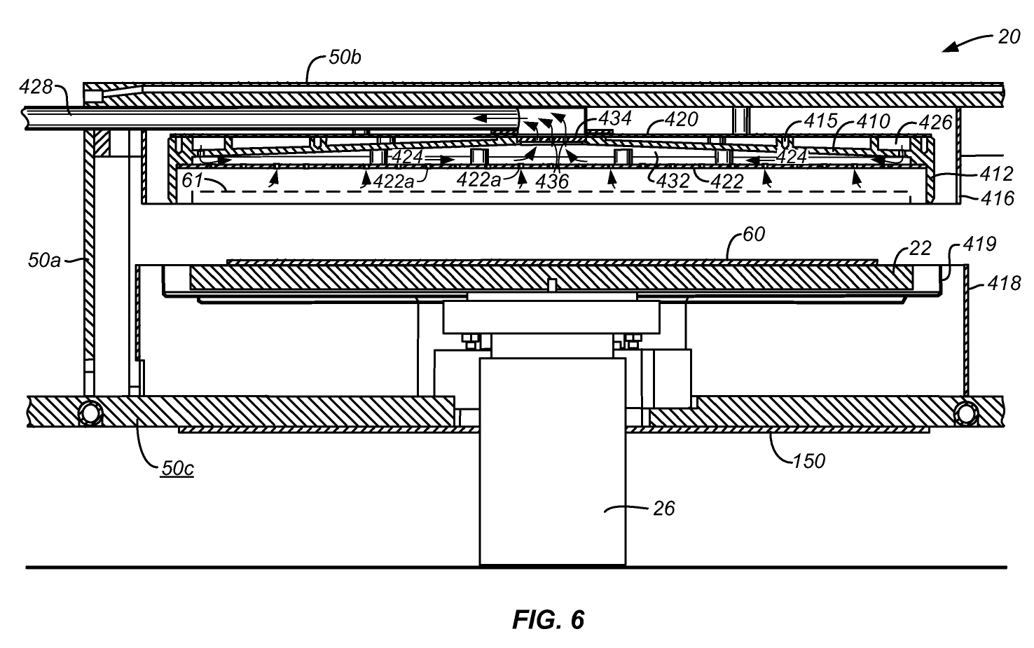

FIG. 4 is a perspective view of bake station 20 shown in FIG. 3 according to one embodiment; FIG. 5 is a perspective view of a cross-section of bake station 20 shown FIG. 4, and FIG. 6 is a cross-sectional view of the bake station 20. As shown in FIGS. 4-6, bake station 20 has three separate isothermal heating elements: bake plate 22, top heat plate 410 and side heat plate 412, each of which is manufactured from a material exhibiting high heat conductivity, such as aluminum or other appropriate material. Each plate 22, 410, and 412 has a heating element, for example resistive heating elements, embedded within the plate. Bake station 20 also includes side, top and bottom heat shields 416 and 418, respectively, as well as a bottom cup 419 that surrounds bake plate 22 and a lid 420 (shown in FIG. 6 only). Each of heat shields 416, 418, cup 419 and lid 420 are made from aluminum. Lid 420 is attached to top heat plate 410 by eight screws through threaded holes 415.

Bake plate 22 is operatively coupled to a motorized lift 26 so that the bake plate can be raised into the clam shell enclosure and lowered into a wafer receiving position. Typically, wafers are heated on bake plate 22 when it is raised to a baking position 61 as shown in FIG. 6. When in baking position 61, cup 419 encircles a bottom portion of side heat plate 412 forming a clam shell arrangement that helps confine heat generated by bake plate 22 within an inner cavity formed by the bake plate and the enclosure. In one embodiment the upper surface of bake plate 22 includes 8 wafer pocket buttons and 17 proximity pins similar to those with respect to shuttle 40 and chill plate 30. Also, in one embodiment bake plate 22 includes a plurality of vacuum ports and can be operatively coupled to a vacuum chuck to secure a wafer to the bake plate during the baking process.

During the baking process, a faceplate 422 is positioned just above and opposite the upper surface of bake plate 22. Faceplate 422 can be made from aluminum as well as other suitable materials and includes a plurality of holes or channels 422a that allow gases and contaminants baked off the surface of a wafer being baked on bake plate 22 to drift through faceplate 422 and into a radially inward gas flow 424 that is created between faceplate 422 and top heat plate 410.

Gas from radially inward gas flow 424 is initially introduced into bake station 20 at an annular gas manifold 426 that encircles the outer portion of top heat plate 410 by a gas inlet line 427. Gas manifold 426 includes numerous small gas inlets 430 (128 inlets in one embodiment) that allow gas to flow from manifold 426 into the cavity 432 between the lower surface of top heat plate 410 and the upper surface of faceplate 422. The gas flows radially inward towards the center of the station through a diffusion plate 434 that includes a plurality of gas outlet holes 436. After flowing through diffusion plate 434, gas exits bake station 20 through gas outlet line 428.

Bake plate 22 heats a wafer substrate 60 according to a particular thermal recipe. One component of the thermal recipe is typically a set point temperature at which the bake plate is set to heat the wafer substrate. During the baking process, the temperature of the wafer support is routinely measured and one or more zones of the bake plate can be adjusted to ensure uniform heating of the substrate. In many embodiments, bake plate 22 is heated to the desired set point temperature while a large batch of wafers are processed according to the same thermal recipe. Thus, for example, if a particular thermal recipe calls for a set point temperature of 175° C. and that recipe is to be implemented on 100 consecutive wafers, bake plate 22 will be heated to 175° C. during the period of time it takes to process the 100 consecutive wafers.

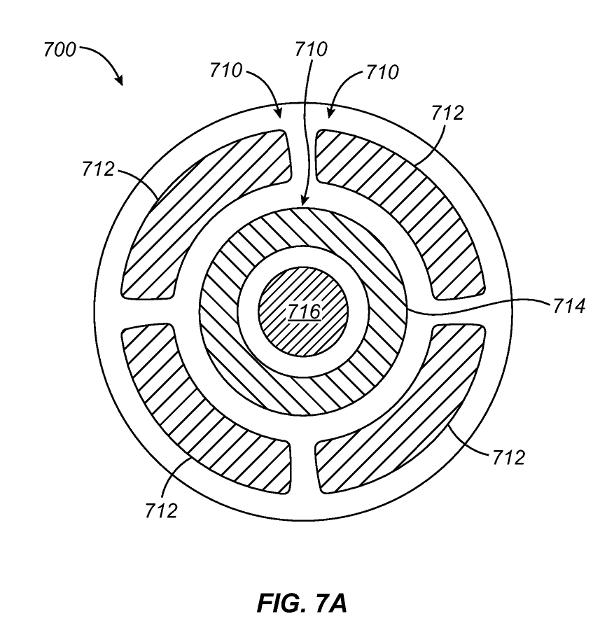

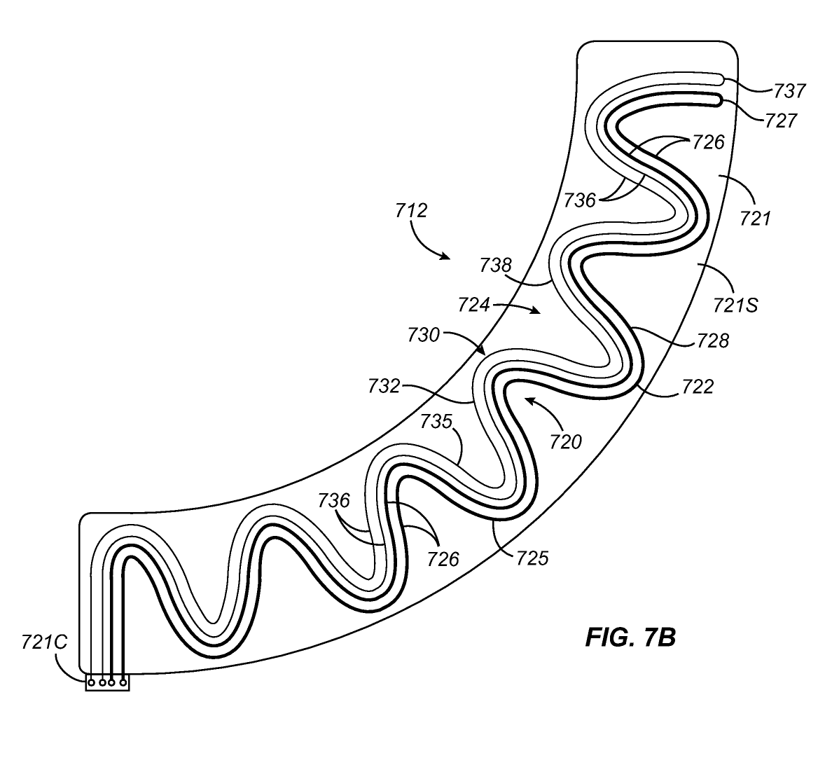

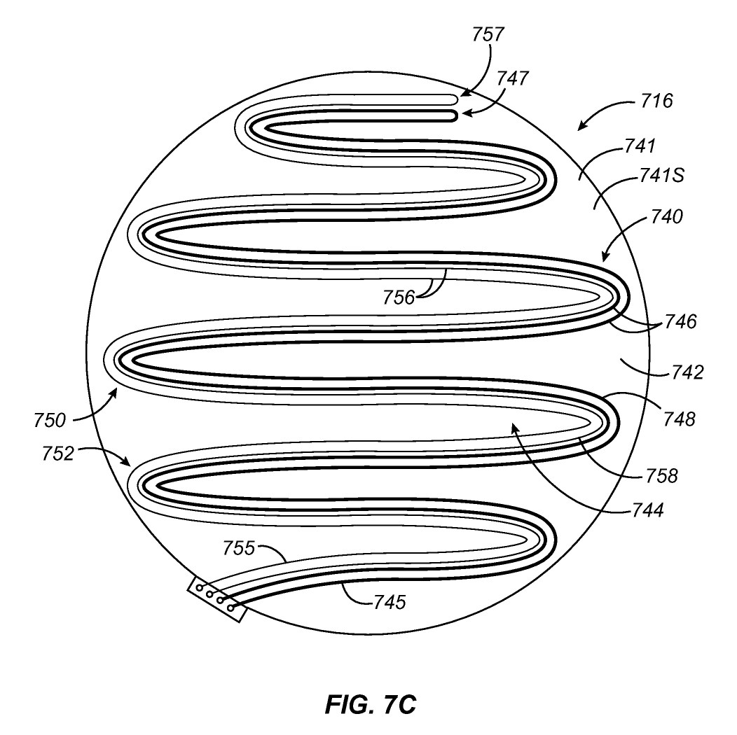

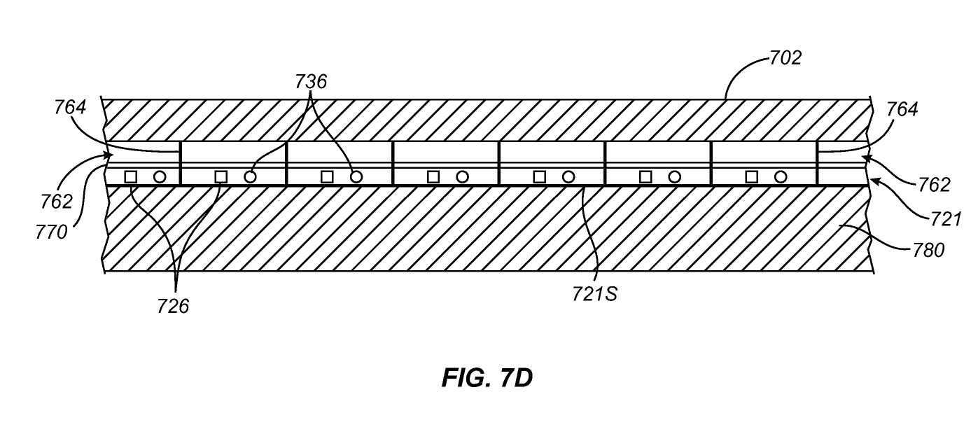

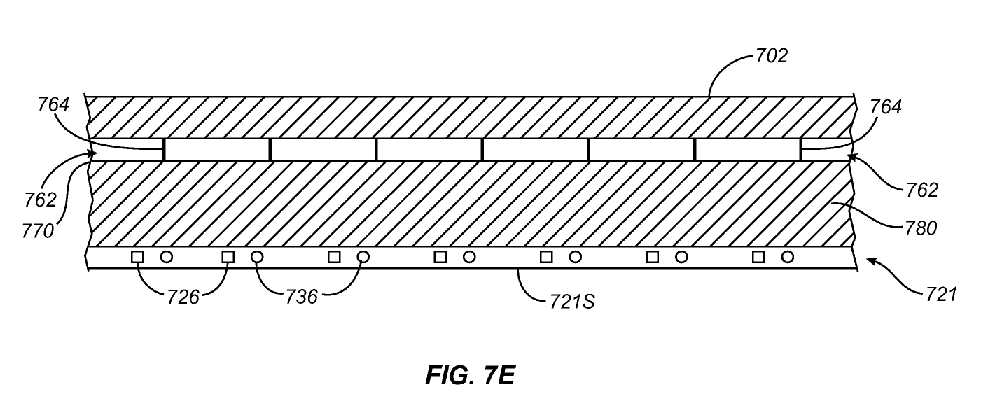

FIG. 7A shows a simplified top view of a bake plate 700 according to embodiments of the present invention. Bake plate 700 has several heating elements 710, for example resistive heating elements, embedded within the plate. Bake plate 700 includes a circular heating element 716 near the center of bake plate 700, and an annular heating element 714 positioned around circular heating element 716. Annular segment heating elements 712 can be positioned around annular heating element 714. In specific embodiments, the annular segment heating elements can be positioned in each of four quadrants around the annular and circular heating elements.

In many embodiments, several elongate thermal sensors, for example several RTD sensor loops, are disposed in bake plate 700 to provide temperature signals that correspond to each of the heating elements of the bake plate. Each heating element can be located in a region that corresponds to a heating zone of the bake plate. In many embodiments, each heating element comprises flex PCB that includes the heating device and thermal sensor supported by a flexible support.

According to embodiments of the invention, a thermal sensing device comprises a resistance temperature detector (RTD) formed from a resistive material. In some embodiments, the RTD device is formed of platinum, because of its linear resistance-temperature relationship and its chemical inertness. The resistance ideally varies linearly with temperature, but any necessary calibrations to eliminate ‘strain guage’ effects caused by the different thermal expansion rates of the substrate and platinum can also be made.

The thermal sensing device can be formed in many patterns, for example serpentine, sinusoidal, a spiral circular pattern with increasing radius, and rectangular rows, as appropriate for the particular application. In many embodiments, the thermal sensing device is formed in view of the shapes and numbers of zones in the multi-zone bake plate. For example, the pattern shown in FIGS. 7B and 7C may span a single heating element in a multi-heating element bake plate. Accordingly, thermal sensing devices may be formed in a pattern along each of the heating elements to provide an average temperature along each heating element. The thermal sensing devices utilized herein may include RTD sensors, thermocouples, thermistors, fiber optic sensors and/or combinations of thereof. In some embodiments that use fiber optic sensors, a time delay and/or path length of reflected light can depend on the temperature of temperature sensitive portions distributed along the fiber optic cable.

FIG. 7B shows a simplified top view of one of the annular segment heating elements 712 of bake plate 700 as in FIG. 7A with an interlaced RTD sensor, according to embodiments of the present invention. An elongate thermal sensor 730, for example RTD sensor 732, can be interlaced with a heat generation device 720 of the heating element. RTD sensor 732 has an electrical resistance that varies with temperature so that an average temperature along the path of the sensor can be determined based on the electrical resistance of the RTD sensor.

In many embodiments, the heating element comprises a flexible PCB 721. Flexible PCB 721 comprises a flexible PCB support 721S, trace 726 and trace 736. Flexible PCB support 721S can support trace 726 of heat generation device 720 and trace 736 of elongate thermal sensor 730. Flexible PCB support 721S can be made from polyimide, for example polyimide sold under the trademark Kapton® available from E.I. du Pont de Nemours and Company. A connector 721C can be located on flexible PCB 721 to connect heat generation device 720 and RTD sensor 730 to external circuit components. In many embodiments, heat generation device 720 comprises a trace 726 formed from a thin layer of conductor 725, and RTD sensor 732 comprises a trace 736 formed from a thin layer of a conductor 735. Trace 736 of heat generation device 720 often comprises a conductor 725 that generates heat as electrical current is passed the heat generation device. Conductor 725 can be made from a metal, for example nichrome, copper and/or aluminum.

Elongate thermal sensor 730 and heat generation device 720 can be shaped to measure the average temperature along heat generation device 720. Trace 726 of heat generation device 720 extends in a path along flex PCB from connector 721C to a turn 727 and from turn 727 back to connector 721C so as to form a loop with a generally sinusoidal pattern. Trace 736 of elongate thermal sensor 730 extends in a path along flex PCB from connector 721C to a turn 737 and from turn 737 back to connector 721C so as to form a loop with a generally sinusoidal pattern. Trace 736 can mesh with trace 726 such that the RTD sensor is interlaced with heat generation device. A portion 728 of trace 726 defines an interstice 724 of the heat generation device and a portion 738 of RTD sensor 732 fits within interstice 724. Each undulation of the generally sinusoidal pattern along the path of the heat generation device provides an interstice, such that several interstices are available to receive portions of the RTD sensor loop. This close, interlaced, fitting of the thermal sensor device along the heat generation device can provide a measurement of the average temperature along the heat generation device.

Elongate thermal sensor 730 can be made from materials that provide reliable and accurate measurements for extended periods of time. In many embodiments, RTD sensor 732 and the other RTD sensors described herein can be made from a soft metal that can expand with the bake plate as the bake plate is heated. A soft metal can be characterized by the modulus of elasticity, Young's modulus. If Young's Modulus is lower, the material will move along with the expanding bake plate more easily, thereby having lower strain so as to have less impact on the measured resistance from that expansion. With respect to softness, suitable metals include Copper, Platinum and Palladium with Young's Moduli of 110 GPa, 171 GPa and 112 GPa, respectively. Work in relation with the present invention indicates that a materials with a Young's modulus of elasticity of no more than about 200 GPa will provide suitable softness in the RTD sensor trace for embodiments of the present invention.

Work in relation with the present invention also indicates that resistance to oxidation is an important characteristic of the RTD sensor material. Oxidation of the surface of RTD sensor 732, and the other RTD sensors described herein, can increase the resistivity of the trace, thereby leading to a shift in temperature readings. In many embodiments, oxidation at room temperature, approximately 293 to 298 degrees Kelvin, can be used as a metric to determine suitable materials, even though the sensor can operate at much higher temperatures. In specific embodiments, suitable metals include metals that are resistant to oxidation room temperature, such that an oxide layer thickness is limited to no more than about 2 nm after exposure of the metal to air at room temperature for about one day. With respect to oxidation resistance, oxide layer thicknesses of Platinum and Palladium after exposure to air for one day at room temperature are about 0.3 nm and 1 nm, respectively.

FIG. 7C shows a simplified top view of the circular heating element of the bake plate as in FIG. 7A with an interlaced RTD sensor, according to embodiments of the present invention. An elongate thermal sensor 750, for example RTD sensor 752, can be interlaced with a heat generation device 740 of the heating element. In many embodiments, RTD sensor 752 comprises a trace 756 formed from a thin layer of a conductor 755. Heat generation device 740 often comprises a conductor 745 that generates heat as electrical current is passed the heat generation device. Conductor 745 can be made from a metal as described above.

In many embodiments, circular heating element 716 comprises a flexible PCB 741. Flexible PCB 741 comprises a flexible PCB support 721S that supports RTD sensor 752 and heat generation device 740. In many embodiments, heat generation device 740 comprises a trace 746 formed from a thin layer of conductor 744. Flexible PCB support 741S can support trace 746 of heat generation device 740 and trace 756 of elongate thermal sensor 750. Flexible PCB support 741S can be made from polyimide as described above. A connector 741C can be located on flexible PCB 741 to connect heat generation device 740 and RTD sensor 750 to external circuit components.

Elongate thermal sensor 750 and heat generation device 740 can be shaped to measure the average temperature along heat generation device 740. Trace 746 of heat generation device 740 extends in a path along the flex PCB from connector 741C to a turn 747 and from turn 747 back to connector 741C so as to form a loop with a generally sinusoidal pattern. Trace 756 of elongate thermal sensor 750 extends in a path along flex PCB from connector 741C to a turn 757 and from turn 757 back to connector 741C so as to form a loop with a generally sinusoidal pattern. Trace 756 can mesh with trace 746 such that the RTD sensor is interlaced with heat generation device. A portion 748 of trace 746 defines an interstice 744 of the heat generation device and a portion 758 of RTD sensor 752 fits within interstice 744. Each undulation of the generally sinusoidal pattern of heat generation device can provide an interstice, such that several interstices defined by portions of the heat generation device can be interlaced with portions of the RTD sensor. This close, interlaced, fitting of the thermal sensor device with the heat generation device can provide a measurement of the average temperature along the heat generation device.

Although a sinusoidal pattern is shown, other patterns can provide interlaced temperature measurements. Parallel lines of the heat generation device, for example rows of parallel lines, can be interlaced with parallel lines of the RTD sensor loop, for example rows of parallel lines of the RTD sensor loop. Spirals, rectangles and other patterns may also be interlaced.

FIG. 7D shows a simplified cross sectional view of a temperature sensor interlaced with a heat generation device as in FIG. 7B, with the interlaced layer positioned between the wafer substrate and substrate support, according to embodiments of the present invention. Positioning of the heat generation layer in proximity to the wafer substrate and above the substrate support may provide rapid heating of the wafer substrate. A wafer substrate 702 can be positioned above a substrate support 780. Proximity pins 764 separate wafer substrate 702 from substrate support 780 so as to form a gap 762 between the wafer substrate and the substrate support. Flexible PCB 721 is positioned between wafer substrate 702 and substrate support 780 and can have holes formed thereon to receive the proximity pins. Trace 726 and trace 736 are supported by flex PCB support 721S and interlaced as described above. A protective layer 770 comprising Kapton and/or glass can be positioned above flexible PCB 721 comprising trace 726 and trace 736 to protect the flexible PCB support and traces from damage, for example damage caused by a wafer that breaks.

FIG. 7E shows a simplified cross sectional view of a temperature sensor interlaced with a heat generation device as in FIG. 7B, with the interlaced layer positioned beneath the substrate support, according to embodiments of the present invention. Wafer substrate 702 can be positioned above substrate support 780. Proximity pins 764 can separate wafer substrate 702 from substrate support 780 so as to form gap 762 between the wafer substrate and the substrate support. Flexible PCB 721 is positioned under the wafer substrate and the substrate support. Trace 726 and trace 736 are supported by flex PCB support 721S and interlaced as described above. A support layer (not shown) may be provided below flexible PCB 721 to hold the flexible PCB in position.

In some embodiments, positioning the interlaced heat generation layer below the substrate support can provide improved uniformity of the heat applied to the wafer substrate. As the substrate support can comprise a highly heat conductive metal, for example aluminum, heat can be conducted along the support layer so that non-uniform heat applied to lower side of the support layer will be spread along the layer to provide uniform heat on the opposing upper side of the substrate support where the wafer substrate is supported. In many embodiments, the substrate support layer can comprise a circular plate of aluminum, approximately 10 mm thick and at least 300 mm across, to accommodate a 300 mm wafer. In many embodiments, the distribution of heat on the upper side of the substrate support beneath the wafer substrate is uniform from about 0.01 to about 0.1 degrees Celsius (C).

The temperature sensor devices can be calibrated in many ways to provide a temperature uniform from about 0.01 to about 0.1° C. on the top surface of the bake plate near the wafer. Such uniformity can be obtained by calibrating many of the temperature sensing devices as described herein in a controlled temperature oven, for example in a controlled temperature oven along with the bake plate. The calibrated temperature sensors and bake plate can then be removed and the calibrated sensors used to control the temperature of the bake plate based the measurements of the calibrated temperature sensors. In some embodiments, the temperature sensors can be calibrated with sensors positioned on a wafer above the bake plate. The controller can detect the measured temperature of each calibrated sensor of the bake plate and control the amount of energy delivered to each heating element of the bake plate in response to the measured temperatures. Work in relation with the present invention indicates that accuracy of the temperature measurements to within about 0.01 to 0.1° C. may not be necessary, and measurements that are repeatable and uniform to within about 0.01 to 0.1 degrees C. can be sufficient to provide a repeatable wafer history process.

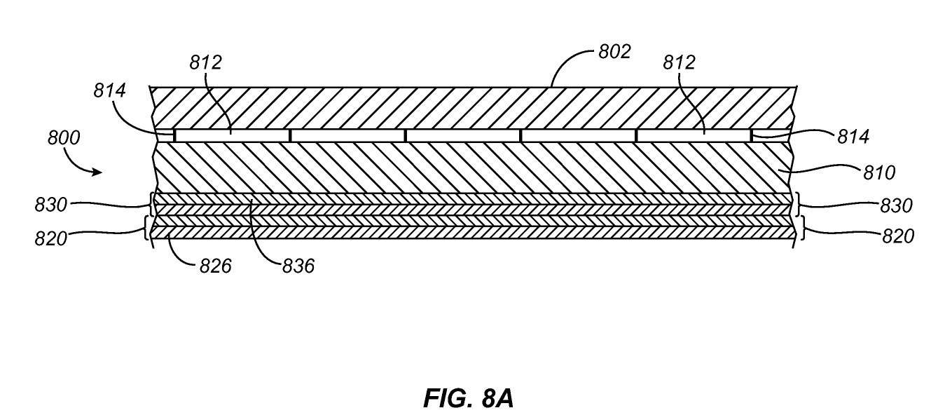

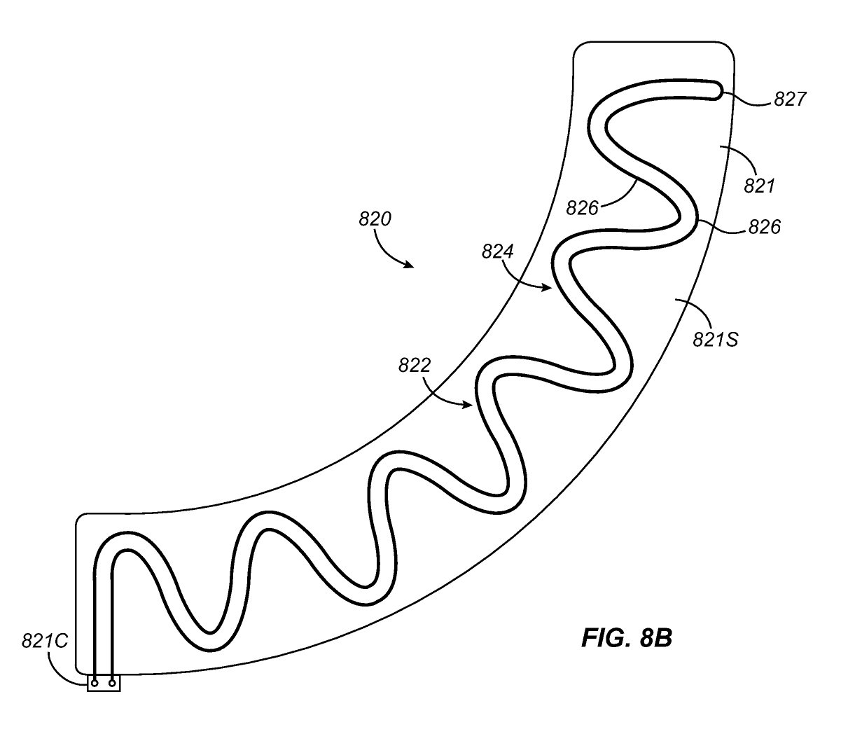

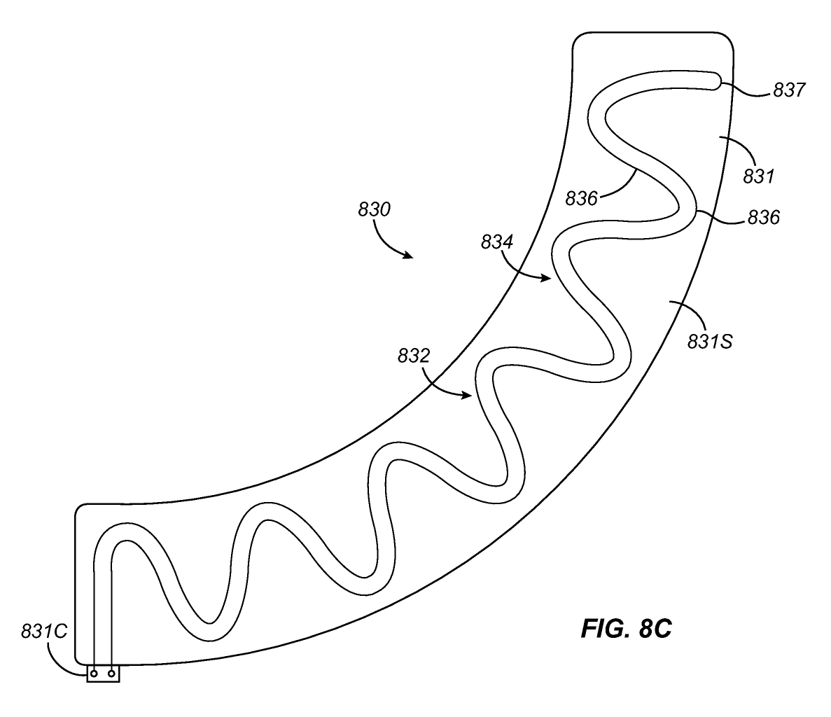

FIG. 8A shows a cross sectional view of a bake plate 800 with an elongate temperature sensor layer 830 positioned between a wafer substrate 802 and a heating element layer 820, according to embodiments of the present invention. Proximity pins 814 are attached to a substrate support 810. Proximity pins 814 separate wafer substrate 802 from substrate support 810 to provide a gap 812 between the substrate support and the backside of wafer substrate 802. Substrate support 810 generally comprises a plate of a highly heat conductive metal as described above to spread non-uniformity in heat from heating element layer 830 and uniformly heat wafer substrate 802 with heat conducted from heating element layer 830 through substrate support 810.

FIG. 8B shows a simplified top view of heating element layer 820 as in FIG. 8A, according to embodiments of the present invention. Heating element layer 820 includes a heat generation device 822 that comprises trace 826. Heating element layer 820 can comprise a flexible PCB 821. Flexible PCB 821 can comprise a flexible PCB support 821S and traces of the heat generation device. A connector 821C can be used to connect heat generation device 822 to a drive circuit. Trace 826 of the heat generation device extends from connector 821C to a turn 827 and from turn 827 to connector 821C in a generally sinusoidal pattern. At least a portion 824 of heat generation device 822 is shaped to correspond with the RTD sensor device. The traces and flexible PCB can be made as described above.

FIG. 8C shows a simplified top view of elongate temperature sensor layer 830 as in FIG. 8A, according to embodiments of the present invention. Elongate temperature sensor layer 830 includes an RTD sensor loop 832 that comprises trace 836. Elongate sensor layer 830 can comprise a flexible PCB 831. Flexible PCB 831 can comprise a flexible PCB support 831S and traces. Flexible PCB support 831S can support RTD sensor loop 832. A connector 831C can be used to connect RTD sensor loop 832 to a resistance measurement circuit. Trace 836 of the RTD sensor loop extends from connector 821C to a turn 837 and from turn 837 to connector 831C in a generally sinusoidal pattern. At least a portion 834 of RTD sensor loop 832 extends along a path that corresponds with a path of the heat generation device. For example, portion 834 of RTD sensor loop 832 can be positioned above portion 824 and extend along portion 824 of heat generation device 822. The traces and flexible PCB can be made as described above.

While the exemplary embodiments have been described in some detail for clarity of understanding and by way of example, a variety of additional modifications, adaptations, and changes may be clear to those of skill in the art. Hence, the scope of the present invention is limited solely by the appended claims, along with the full scope of their equivalents.

What is claimed is:

1. A device for heating a semiconductor wafer, the device comprising:
a heating element arranged to conduct heat toward the wafer, the heating element extending along a heating element path; and
a temperature sensor extending along a temperature sensor path, wherein the temperature sensor path is positioned along the heating element path to measure a temperature that corresponds to the heating element.

2. The device of claim 1 wherein the temperature sensor measures an average temperature along the heating element.

3. The device of claim 2 wherein the temperature sensor extends along a layer of a semiconductor bake plate and the average temperature along the heating element corresponds to the temperature of the layer.

4. The device of claim 1 wherein portions of the temperature sensor are interlaced between portions of the heating element.

5. The device of claim 4 wherein the heating element path is arranged with interstices between portions of the heating element path and wherein portions of the temperature sensor path are positioned within the interstices to interlace the temperature sensor loop with the heating element.

6. The device of claim 5 wherein the heating element comprises a loop and substantially parallel segments of the loop define the interstices.

7. The device of claim 1 wherein the heating element and the temperature sensor path are located on a printed circuit board.

8. The device of claim 1 wherein the temperature sensor comprises an RTD sensor and a sensor path comprises an RTD sensor loop with a soft metal that is resistant to oxidation and extends along the sensor path.

9. The device of claim 8 wherein the metal comprises at least one of platinum, gold or palladium.

10. The device of claim 8 wherein the metal has a Young's modulus of elasticity of no more than about 200 GPa.

11. The device of claim 8 wherein the oxidation resistant metal is capable of forming an oxide layer no more than about 2 nm thick after one day of exposure to air at room temperature.

12. The device of claim 1 wherein the heating element path is located on a first layer of the device, and the temperature sensor path is located on a second layer of the device, wherein heat conducts from the first layer through the second layer to heat the semiconductor wafer.

13. The device of claim 12 further comprising a substrate layer to support the semiconductor wafer, the substrate layer comprising a metal and positioned between the wafer and the first layer to spread heat from the first layer along the substrate layer and heat the wafer with heat conducted along the substrate layer.

14. The device of claim 13 wherein the second layer is positioned between the substrate layer and the wafer.

15. The device of claim 13 wherein proximity pins extend from the substrate layer toward the wafer so as to position the wafer at a predetermined distance from the substrate layer.

16. A method of measuring a temperature of a bake plate used to heat a semiconductor wafer, the method comprising:
heating several heating elements, wherein each of the several heating elements extends along a heating element path;
measuring a temperature for each of several temperature sensors, wherein each of the several temperature sensors extends along the heating element path of one of the several heating elements to measure a temperature that corresponds to one of the several heating elements.

17. The method of claim 16 wherein the several heating elements are arranged in a layer of the bake plate.

18. The method of claim 17 wherein the temperature sensors are located in the layer and measure the temperature of the layer.

19. The method of claim 18 wherein the temperature of the layer is uniform to within about 0.01° C. to 0.1° C.

20. The method of claim 17 wherein the temperature sensors are located in a layer positioned between the wafer and the heating element layer and heat is conducted from the heating element layer through the temperature sensor layer toward the wafer.

21. A device for heating a semiconductor wafer, the device comprising:
several heating elements arranged to conduct heat toward the wafer; and
several RTD sensors, wherein each of the several RTD sensors extends along a path that is positioned to correspond to one of the several heating elements.

22. The device of claim 21 wherein the several RTD sensors are adapted to measure a temperature uniformity from about 0.01° C. to about 0.1° C. among the heating elements.

23. The device of claim 21 wherein each of the several heating elements extends along a heating element path that defines interstices and wherein the corresponding RTD sensor extends into the interstices.

24. The device of claim 21 wherein the RTD sensors are located in a layer and each RTD sensor is positioned along the layer between the corresponding heating element and the wafer.

25. The device of claim 24 further comprising a substrate layer located between the wafer and the heating elements, wherein the substrate layer comprises a metal adapted to conduct heat along the layer toward the wafer.

26. A PCB for use with a semiconductor bake plate, the PCB comprising:
a flexible support;
a heating element loop trace formed on the flexible support and extending along the flexible support; and
an RTD sensor loop trace formed on the flexible support and extending along the flexible support, wherein the RTD sensor loop trace comprises a soft and oxidation resistant metal;
wherein the RTD sensor loop trace is interlaced with the heating element loop trace.

27. The PCB of claim 26 wherein the RTD sensor loop trace comprises substantially parallel portions and the substantially parallel portions are interlaced with the heating element trace.

28. The PCB of claim 26 wherein the soft oxidation resistant metal has a Young's modulus of elasticity that is no more that about 200 GPa and is capable of forming an oxide layer no more than about 2 nm thick after exposure to air for about a day at room temperature.

29. The PCB of claim 26 wherein the soft and oxidation resistant metal comprises at least one of Palladium or Platinum.
